(19) United States
(12) Patent Application Publication
(10) Pub. No.: US 2026/0320409 A1
(43) Pub. Date: Oct. 15, 2026

(54) LEARNING METHOD FOR DETERMINING RESOURCE ALLOCATION RATIO OF CONTINUAL LEARNING MODEL AND APPARATUS PERFORMING SAME

(71) Applicant: CHUNG ANG UNIVERSITY INDUSTRY ACADEMIC COOPERATION FOUNDATION, Seoul (KR)

(72) Inventors: EUN WOO KIM, Seoul (KR); KI SEONG HONG, Busan (KR)

(21) Appl. No.: 19/466,867

(22) Filed: Feb. 2, 2026

(30) Foreign Application Priority Data
Mar. 12, 2025 (KR) 10-2025-0032283

(51) Int. Cl. G06N 3/096; G06F 17/18

(52) U.S. Cl. CPC G06N 3/096; G06F 17/18

(57) ABSTRACT

In a learning method for determining a resource allocation ratio of continual learning model, a learned parameter set obtained by performing learning on a previous task is acquired by a continual learning model, and a resource allocation ratio between an exploration ratio for learning information of the new task with respect to the parameter set and an exploitation ratio for retaining knowledge of the previous task when the new task is input is determined by a resource allocation model.

### CROSS-REFERENCE TO RELATED APPLICATION AND CLAIM OF PRIORITY

This application claims the benefit under 35 USC § 119 of Korean Patent Application No. 10-2025-0032283, filed on Mar. 12, 2025, in the Korean Intellectual Property Office, the entire disclosure of which is incorporated herein by reference for all purposes.

### BACKGROUND

### 1. Technical Field

The present disclosure relates to the field of artificial intelligence and deep learning technology, and more particularly, to a method of maximizing learning performance by automatically exploring optimal resource allocation in a continual learning environment.

### 2. Description of Related Art

Continual learning is a technique that gradually improves performance while retaining previously learned information when a model learns a new task, and is being treated as an important research topic in various application fields. However, existing continual learning methods generally performed resource allocation between tasks in a fixed manner, or distributed resources to all tasks at the same ratio. In this method, since uniform resource allocation is applied even though the amount of resources required for each task is different, unnecessary resource waste occurs in some tasks and sufficient learning is not performed in other tasks, which are problematic. In addition, when a new task is introduced, the “catastrophic forgetting” in which knowledge from a previous task is lost may occur, and a parameter isolation technique may be used to solve this problem. However, this method has limitation of consuming excessive resources to preserve all previous tasks. Therefore, in the present disclosure, in order to solve the problems of the existing methods, research on a learning method of optimizing resource competition between consecutive tasks and dynamically adjusting an optimal resource allocation amount for each task is required in the industry.

Examples of related art include Korean Registered Patent No. 10-2399533.

### SUMMARY

The present disclosure is derived in response to the above-described background technology, and is to maximize learning performance by optimally distributing resources for each task in a continual learning environment. The core of the present disclosure is to solve the fixed resource allocation problem that occurs in the existing continual learning technique and to automatically allocate appropriate resources as needed for each task. To this end, a new learning method that optimizes a balance between exploration and exploitation between two consecutive tasks is proposed, and an resource allocation model is introduced to adjust resource competition and dynamically determine an optimal exploration ratio and exploitation ratio. In addition, it is intended to improve the efficiency of continual learning by applying a method of selectively re-learning only some parameters of a previous task in order to prevent performance degradation of the previous task.

An object of the present disclosure is to ultimately enable more stable learning by enabling a model to effectively retain information from the previous task while learning a new task in a continual learning environment.

As a means for achieving the above-described technical problems, according to one aspect of the present disclosure, the above-described problem solving means are merely illustrative and should not be construed as an intention to limit the present disclosure. In addition to the exemplary embodiments described above, there may be additional embodiments described in the drawings and detailed description of the invention.

As a means for achieving the above-described technical problems, a learning method according to an embodiment of the present disclosure is a learning method that is performed on a computing device including one or more processors and a memory storing one or more programs executed by the one or more processors and includes acquiring, by a continual learning model, a learned parameter set obtained by performing learning on a previous task, and determining, by a resource allocation model, a resource allocation ratio between an exploration ratio for learning information of the new task with respect to the parameter set and an exploitation ratio for retaining knowledge of the previous task when the new task is input.

The determining of the resource allocation ratio may include calculating a probability distribution by inputting the previous task into the resource allocation model, and determining the exploration ratio and the exploitation ratio based on the probability distribution.

The probability distribution may be calculated by the resource allocation model receiving the previous task as input and probabilistically calculating the exploitation ratio of a parameter for each layer in a continual learning model so that an optimal exploitation ratio is selected in each layer.

The probability distribution of the resource allocation model may be calculated by

$$𝒫 = softmax ( A ( {x}_{n}^{t - 1} ; 𝒲 ) ) ∈ {ℝ}^{K \times L} .$$

The determining of the exploration ratio and the exploitation ratio may include determining an exploitation ratio of a parameter for each of a plurality of layers of the previous task based on a probability value for each layer according to the probability distribution, and determining a residual resource except for the determined exploitation ratio among the parameter set as an exploration ratio to be allocated to the new task.

The learning method may further include performing learning on the new task by the continual learning model, and the performing of the learning on the new task may include acquiring, by the continual learning model, the resource allocation ratio between the exploration ratio and the exploitation ratio determined by the resource allocation model, and learning, a new task by allocating a parameter according to the resource allocation ratio determined to the new task.

The resource allocation model may be trained through a preset loss function using a result of the continual learning, and the loss function may include an allocation loss function that allows the continual learning model to perform optimal resource distribution by minimizing a learning loss between the previous task and the new task.)

The allocation loss function may be expressed by

$${ℒ}_{alloc} = {𝔼}_{{E}^{t - 1} \sim A} {\sum }_{i = t - 1}^{t} {\sum }_{n = 1}^{{N}^{i}} {ℒ}_{task} ( C ( {x}_{n}^{i} ; {Θ}^{t} , {E}^{i} ) ) .$$

The loss function may further include a sparsity loss function for preventing excessive exploitation of parameter resources from the previous task in the continual learning model.

The sparsity loss function may be expressed by

$${ℒ}_{sparse} = \frac{1}{L} {\sum }_{l = 1}^{L} {( \frac{{e}_{l}^{t - 1}}{τ} )}^{2} .$$

The resource allocation model may be trained to minimize a sum of the allocation loss function and the sparsity loss function.

The learning method may further include re-learning, by the continual learning model, the previous task through the preset loss function based on the optimal allocation ratio and optimizing the parameter of the previous task through the re-learning.

The loss function for the re-learning may be expressed by

$${min}_{{\tilde{θ}}^{t - 1}} {ℒ}_{task} ( C ( {x}_{n}^{i} ; {Θ}^{t} , {\tilde{E}}^{i} ) ) .$$

A computing device according to another aspect of the present disclosure is a computing device that includes a processor and a memory storing one or more programs executed by the processor, and the processor is configured to perform an operation of acquiring, by a continual learning model, a learned parameter set obtained by performing learning on a previous task, and an operation of determining, by a resource allocation model, a resource allocation ratio between an exploration ratio for learning information of the new task with respect to the parameter set and an exploitation ratio for retaining knowledge of the previous task when the new task is input.

The processor may be further configured to perform an operation of performing learning on the new task by the continual learning model, and the operation of performing learning on the new task may further include an operation of acquiring, by the continual learning model, the resource allocation ratio between the exploration ratio and the exploitation ratio determined by the resource allocation model, and an operation of learning, a new task by allocating a parameter according to the resource allocation ratio determined to the new task.

A computer program according to still another aspect of the present disclosure is a computer program stored in a non-transitory computer readable storage medium, in which the computer program includes one or more instructions, and the instructions, when executed by a computing device including one or more processors, cause the computing device to perform acquiring, by a continual learning model, a learned parameter set obtained by performing learning on a previous task and determining, by a resource allocation model, a resource allocation ratio between an exploration ratio for learning information of the new task with respect to the parameter set and an exploitation ratio for retaining knowledge of the previous task when the new task is input.

### BRIEF DESCRIPTION OF THE DRAWINGS

The accompanying drawings below in order to be used in the description of the embodiments of the present disclosure are only a part of the embodiments of the present disclosure, and other drawings may be obtained by those skilled in the art to which the present disclosure pertains (hereinafter, referred to as “a person skilled in the art”) based on the drawings without efforts to reach a novel invention.

FIG. 1 is a block diagram showing the configuration of a computing device that determines a resource allocation ratio of a continual learning model according to an embodiment of the present disclosure.

FIG. 2 is a flowchart illustrating an operating method of a resource allocation model according to an embodiment of the present disclosure.

FIG. 3 is a flowchart of an operation principle regarding an exploitation ratio and an exploration ratio determination for a new task according to an embodiment of the present disclosure.

FIG. 4 is a diagram for describing a difference from an existing parameter isolation approach according to an embodiment of the present disclosure.

FIG. 5 is a flowchart for exploring optimal resource allocation according to a continual learning model and optimizing an resource allocation model using a loss function according to an embodiment of the present disclosure.

FIG. 6 is a diagram illustrating learning of a continual learning model based on an exploration ratio and an exploitation ratio and optimization of an resource allocation model using a loss function according to an embodiment of the present disclosure.

FIG. 7 is a diagram illustrating the results of resource competition based on an exploration ratio and an exploitation ratio of a uniform allocation method and a continual learning model according to an embodiment of the present disclosure.

### DETAILED DESCRIPTION

The following detailed description is provided to aid in a comprehensive understanding of the methods, apparatuses, and/or systems described herein. However, this is only an example, and the present disclosure is not limited thereto.

In describing the embodiments of the present disclosure, when it is determined that a detailed description of known technology related to the present disclosure may unnecessarily obscure the gist of the present disclosure, the detailed description thereof will be omitted. Terms to be described below are defined in consideration of functions in the present disclosure, and may vary depending on a user, an intention or a practice of an operator, etc. Therefore, the definition should be made based on the contents throughout this specification. The terms used in the detailed description are merely for describing the embodiments of the present disclosure, and should not be limited. Unless clearly used otherwise, the singular expressions include the meaning of plural forms. In this description, expressions such as “including” or “having” are intended to indicate certain features, numbers, steps, operations, elements, portions or combinations thereof, and should not be construed to exclude the presence or possibility of one or more other features, numbers, steps, operations, elements, portions or combinations thereof other than those described.

In addition, terms such as first and second may be used to describe various components, but the components should not be limited by the terms. The terms may be used as the purpose of distinguishing one component from another. For example, a first component could be termed a second component, and, similarly, a second component could be termed a first component, without departing from the scope of the present disclosure.

The present disclosure proposes a method of effectively learning a new task based on information learned from a previous task by using a continual learning model. The continual learning model of the present disclosure operates by determining an optimal exploration and exploitation strategy by adjusting resource competition between tasks, thereby minimizing loss of knowledge and maximizing learning performance.

The continual learning model allows an appropriate learning strategy to be applied to newly introduced data while effectively retaining previously learned information when gradually learning a new task. Through this, the continual learning model is designed to solve the problem of loss of previous knowledge and enable continual learning. The learning model of the present disclosure provides a balanced learning structure that maximally exploits previously learned information while exploring a new task.

Hereinafter, embodiments of the present disclosure will be described in detail with reference to the drawings attached to this specification.

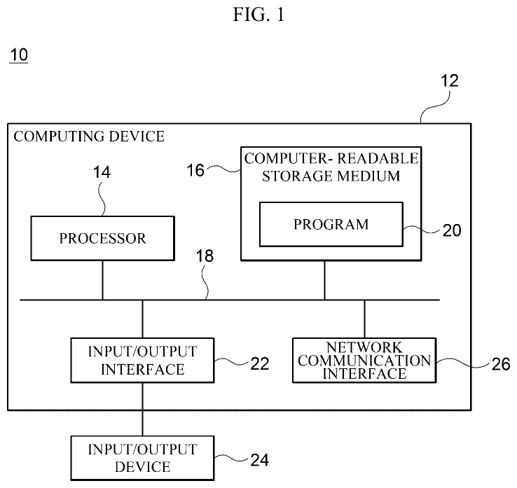

FIG. 1 is a block diagram showing the configuration of a computing device that determines a resource allocation ratio of a continual learning model according to an embodiment of the present disclosure. In the illustrated embodiment, respective components may have different functions and capabilities other than those described below, and include additional components in addition to those described below.

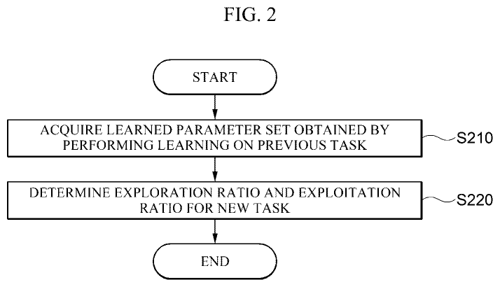

An illustrated computing environment 10 includes a computing device 12. In an embodiment, the computing device 12 may be a device that performs a method for determining a resource allocation ratio of a continual learning model described with reference to FIGS. 2 to 7.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

FIG. 2 is a flowchart illustrating an operating method a resource allocation model according to an embodiment of the present disclosure. This operating method may be performed by the computing device 12. FIG. 2 illustrates a process in which a continual learning model of the present disclosure acquires a parameter learned from a previous task and determines an exploration ratio and exploitation ratio for a new task based on the acquired parameter. The continual learning model may establish a learning strategy that adjusts resource competition based on the concept of exploration and exploitation.

Exploration may be a process of newly adjusting some parameters of a model to learn new information instead of retaining existing knowledge when learning a new task, and the higher the exploration ratio, the less affected by previous knowledge, and learning about a new task may be strengthened. On the other hand, exploitation may be a process of retaining the knowledge learned from the previous task and applying the knowledge to the new task, and the higher the exploitation ratio, the more actively the previously learned parameters are reused, and the focus may be on retaining existing knowledge rather than adapting to a new task.

In step S210, the computing device 12 may acquire a parameter set learned from a previous task. In a continual learning environment, effectively retaining past learning information may be an important factor when learning the new task. To this end, the computing device 12 may be designed to store weight information of the continual learning model learned from the previous task, and use this information when learning a new task D^{t} based on this.

θ^{t} may refer to an entire parameter set to be used in a t-th task, and this set may be composed of a parameter retained from the previous task and a parameter learned in the new task. In this case, \tilde{θ}ⁱ may represent a parameter retained through exploration and exploitation in an i-th (1≤i≤t−1) task, and this may be continuously used in the new task by reflecting learning information from a past task. In addition, θ^{t} may refer to a parameter learned for the new task D^{t}, which may be designed to be learned in harmony with previous parameters.

The computing device 12 may perform learning of the new task D^{t} on a continual learning model by using the parameter set stored as described above. In this case, learning may be performed not simply by retaining all information of the previous task, but by preserving or adjusting only some key parameters. This is to enable new information to be effectively learned while retaining previous model performance when learning a new task.

In step S220, when learning the new task D^{t}, the computing device 12 may perform a process of optimizing an exploration ratio and a resource allocation ratio for the new task while retaining information learned from a previous task. This may be an important factor in preventing performance degradation by effectively learning new tasks while retaining previous knowledge in a continual learning environment. Therefore, in this stage, a strategy may be required that efficiently exploring for a new task while appropriately using information learned from the previous task.

The exploration ratio and exploitation ratio may be defined as follows.

$${E}^{t - 1} = ( {e}_{1}^{t - 1} , … , {e}_{L}^{t - 1} ) . \qquad [ Equation 1 ]$$

$${E}^{t} = ( {e}_{1}^{t} , … , {e}_{L}^{t} ) .$$

$${e}_{l}^{t} = 1 - {e}_{l}^{t - 1}$$

E^{t-1} may refer to the exploitation ratio of the parameter used in the previous task, and this value may be used to determine how much information learned from the previous task should be retained. In contrast, E^{t} may indicate an exploration ratio of a parameter to be used in a new task, which may be adjusted to effectively learn new information while retaining previous knowledge. In addition,

$${e}_{l}^{t}$$

may refer to an exploration ratio in the l-th layer, which may have an inversely proportional relationship with a previous exploitation ratio

$${e}_{l}^{t - 1} .$$

That is, if the exploitation ratio in the previous task is high, the exploration ratio in the new task may decrease, and conversely, if the exploitation ratio in the previous task is low, the exploration ratio in the new task may increase.

In a continual learning environment, maintaining a balance between previous information and new information may act as an important issue. When information of the previous task is excessively preserved, learning of the new task may be limited, and conversely, if the learning of the new task is prioritized, there is a possibility that the performance of the previous task degrades, that is, a problem known as catastrophic forgetting may occur. In order to prevent this, in the present disclosure, a method in which a continual learning model dynamically adjusts the layer-specific exploration ratio and exploitation ratio may be applied. That is, in a layer that plays an important role in the previous task, the exploitation ratio is set high to preserve previous information, and in a layer that is relatively less important, the exploration ratio is increased, enabling new information to be actively learned.

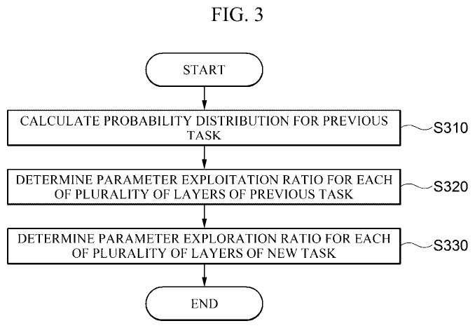

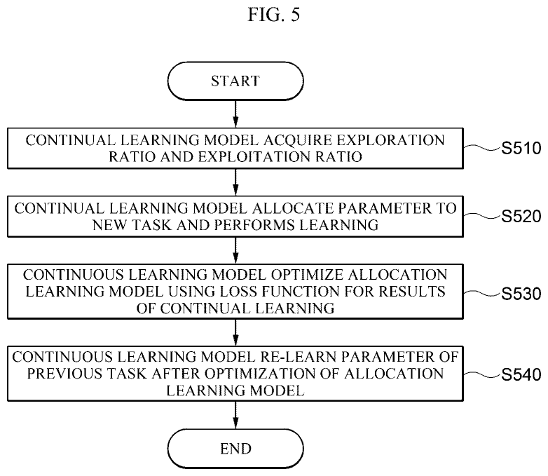

In particular, when the similarity between the new task and the previous task is high, learning may be performed by retaining more previous information and conversely, when the difference between the new task and the previous task is large, learning of new information may be strengthened by increasing the exploration ratio. Through this, the continual learning model may be designed to perform optimal resource allocation, thereby maximizing learning performance. In addition, in the present disclosure, a resource allocation optimization algorithm is applied to dynamically adjust the exploration ratio and exploitation ratio for each layer, thereby enabling the model to learn more stably and efficiently. In this regard, description will be made in detail with reference to FIGS. 3 and 5.

FIG. 3 is a flowchart illustrating an operation principle regarding an exploitation ratio and an exploration ratio determination for a new task according to an embodiment of the present disclosure. The operation in FIG. 3 may be performed by the computing device 12.

FIG. 3 illustrates a process of acquiring parameter information learned from a previous task, calculating a probability distribution based on the acquired parameter information, and determining a parameter exploitation ratio and exploration ratio in each layer using the calculated probability distribution. The continual learning model may be designed to adjust resource competition at each layer and determine optimal exploitation and exploration strategies. This enables effective learning of a new task while preventing loss of previous knowledge.

In step S310, a process of calculating a probability distribution based on information learned from a previous task may be performed. In a continual learning environment, determining the extent to which previously learned information should be used when learning a new task may be an important factor. To this end, the present disclosure calculates a probability distribution for each layer, thereby enabling measurement of the importance of learned information.

The probability distribution may be defined as follows.

$$𝒫 = softmax ( A ( {x}_{n}^{t - 1} ; 𝒲 ) ) ∈ {ℝ}^{K \times L} \qquad [ Equation 2 ]$$

[symbol] is the probability distribution of an exploitation ratio, A is a neural network that constitutes a resource allocation model,

$${x}_{n}^{t - 1}$$

is an n-th data sample of a previous task, [symbol] is a learnable parameter that determines an exploitation ratio, K is the number of exploitation ratio hyperparameters, and L represents the number of layers of a neural network. This enables the continual learning model to learn how important information from the previous task is in a specific layer.

Based on the probability distribution, the continual learning model may determine whether to retain information learned from the previous task or to use it when learning a new task. When information learned in a specific layer is important, a high probability may be allocated to retain previous information, and conversely, when it is necessary to focus on a new task, a low probability may be allocated to enable exploration. This enables continual learning models to learn by appropriately combining previous information and new information.

In step S320, a process of determining the exploitation ratio of the previous parameter in each layer to preserve the information learned from the previous task may be performed. The continual learning model may be designed to adjust information exploitation ratio for each layer in consideration of the importance of the parameters learned from the previous task.

The exploitation ratio may be defined as follows.

$${E}^{t - 1} = ( {e}_{1}^{t - 1} , … , {e}_{L}^{t - 1} ) \qquad [ Equation 3 ]$$

Here, E^{t-1} may refer to an exploitation ratio of a parameter learned from a previous task, which may be an important factor in determining the extent to which previously learned information should be retained. When the exploitation ratio in a specific layer is high, more information from the previous task may be retained, and when the exploitation ratio is low, more resources may be allocated to learning a new task.

The exploitation ratio at each layer may be dynamically adjusted based on the probability distribution. For example, layers that play a more critical role in the previous task, the higher the exploitation ratio may be retained, and on the contrary, for layers that are less important, the exploitation ratio is lowered to allow more new information to be learned. This enables continual learning model to effectively learn new information while minimizing the loss of previous information.

In step S330, a process of determining a parameter ratio to be explored in each layer to learn a new task may be performed. Resources not allocated in the previous task are assigned to a new task, allowing the model to effectively learn new information.

The exploration ratio may be defined as follows.

$${E}^{t} = ( {e}_{1}^{t} , … , {e}_{L}^{t} ) . \qquad [ Equation 4 ]$$

$${e}_{l}^{t} = 1 - {e}_{l}^{t - 1}$$

Here, E^{t} may refer to an exploration ratio of a parameter to be used in a new task, which may have an inversely proportional relationship with the previous exploitation ratio E^{t-1}. That is, if the exploitation ratio in the previous task is high, the exploration ratio in the new task may decrease, and conversely, if the exploitation ratio in the previous task is low, the exploration ratio in the new task may increase.

The exploration ratio at each layer may be dynamically adjusted in consideration of the previous exploitation ratio. For example, when the similarity between the previous task and the new task is high, learning may be performed by increasing the exploitation ratio of the previous parameter and decreasing the exploration ratio. On the other hand, when the difference between the new task and the previous task is large, the exploration ratio may be increased to allocate more resources to learning new information.

This enables the continual learning model to perform effective learning while retaining a balance between the previous task and the new task. In particular, resources may be adjusted by increasing the exploration ratio as the difference between the new task and the previous task increases, and increasing the exploitation ratio as the difference between the new task and the previous task is similar to the previous task.

As described with reference to FIG. 3, the continual learning model of the present disclosure calculates a probability distribution based on information learned from a previous task, and optimizes the exploitation ratio and exploration ratio in each layer using the probability distribution. This enables effective learning of new information while minimizing the loss of previous information, thereby retaining stable model performance over the long term.

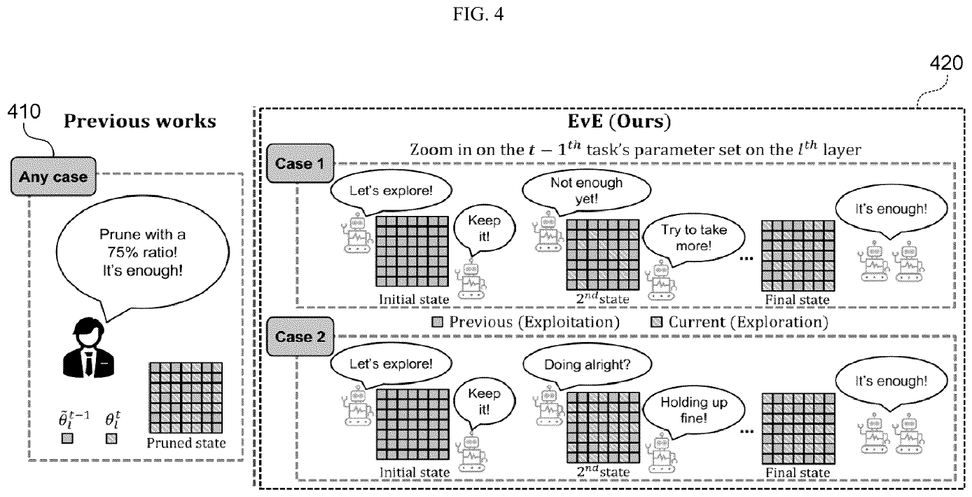

FIG. 4 is a diagram for describing a difference from a previous continual learning method according to an embodiment of the present disclosure. Reference numeral 410 shows the learning method used in existing studies. In the existing method, a method of pruning weights at a certain ratio is used to reduce the size of a model. In existing studies, continual learning may be performed by removing a certain proportion of the weights learned from the previous task, which has the advantage of reducing the complexity of the model and optimizing the amount of computation. However, this method may result in loss of some of the learned information, and knowledge from previous tasks may not be sufficiently retained when learning a new task later.

As shown in reference numeral 410, in existing studies, learning is performed by reducing the size of the model by pruning a certain percentage of weights, which may result in information loss in the continual learning model. If the knowledge of the existing task is not sufficiently reflected when learning a new task, there is a possibility that performance degradation may occur, and as a result, the long-term learning stability of the continual learning model may not be retained.

Reference numeral 420 shows a case where the method of the present disclosure is applied. In the present disclosure, when learning a new task, a strategy for dynamically adjusting the exploration ratio and exploitation ratio for each layer may be applied so that the information from the previous task may be effectively explored while retaining information from the previous task as much as possible. Unlike existing research approaches, the method of the present disclosure may operate by dynamically adjusting the exploration ratio and exploitation ratio for each specific layer during a continual learning process to maximize learning performance. This enables the continual learning model to efficiently learn a new task while effectively preserving previous information and retain stable learning performance over the long term.

Reference numeral 420 illustrates two cases to which the method of the present disclosure is applied, and in the first case, after an exploration is performed in an initial state, additional exploration may be performed when it is determined that the explored information is not sufficient. Thereafter, when the explored information reaches a sufficient state, the exploration may be terminated and the learned weight may be fixed, which ensures that the information from the previous task may be properly retained. In the second case, exploration is performed in an initial state, and after a process of checking whether the explored information is properly retained, when it is determined that the information is sufficiently preserved, the learning may be completed by minimizing the exploration. This approach can provide a balanced learning model that can properly adapt to a new task while preserving information of a previous task in a continual learning environment, and can effectively learn new knowledge while minimizing the loss of existing knowledge.

In conclusion, as described with reference numeral 420, the method of the present disclosure may operate by dynamically adjusting the exploration ratio and exploitation ratio in the learning process to maximize continual learning performance, unlike the conventional method. This enables the continual learning model to efficiently learn a new task while effectively preserving previous information, and retain stable learning performance over the long term.

FIG. 5 is a flowchart for optimizing an resource allocation model using an optimal resource distribution ratio and a loss function according to a continual learning model according to an embodiment of the present disclosure. FIG. 5 illustrates an overall process in which the continual learning model determines an exploration ratio and an exploitation ratio through a resource allocation model, then performs learning of a new task, and retrains an optimized model. The operation in FIG. 5 may be performed by the computing device 12.

In step S510, before learning a new task, the continual learning model may determine an exploration ratio and an exploitation ratio through a resource allocation model based on information learned from a previous task. Here, the exploration ratio may refer to a ratio of resources allocated for learning the new task, and the exploitation ratio may refer to a ratio of resources allocated to retain information from the previous task. In general, in continual learning, it is necessary to learn new information while preventing loss of previous information, and thus, it may be important to appropriately adjust the exploration ratio and exploitation ratio when a new task is added.

The exploration ratio and exploitation ratio may be defined as follows.

$${E}^{t} = ( {e}_{1}^{t} , … , {e}_{L}^{t} ) . \qquad [ Equation 5 ]$$

$${E}^{t - 1} = ( {e}_{1}^{t - 1} , … , {e}_{L}^{t - 1} )$$

Here, E^{t} may indicate an exploration ratio at the current time point t, and each element

$${e}_{l}^{t}$$

may refer to an exploration ratio at the l-th layer of the model. In addition,

$${e}_{l}^{t - 1}$$

may indicate an exploitation ratio at the previous time point t−1, and an exploration ratio at the current time point may be determined based on the exploitation ratio. This may refer to that if the ratio of resources used in the previous task is high, the exploration ratio in the new task may decrease, and conversely, if the exploitation ratio of the previous task is low, the exploration ratio in the new task may increase. This enables the continual learning model to effectively learn new information while retaining previous information without loss.

In step S520, when the exploration ratio and the exploitation ratio are determined, the continual learning model may allocate a parameter for learning a new task based on the corresponding ratios. Some of the parameters learned by the previous model may be reused for learning a new task, and the rest may be optimized in the exploration process to learn new information. The continual learning model may perform the exploration process to effectively learn a new task while retaining parameters that played an important role in the previous task.

A parameter set used by the continual learning model may be expressed as follows.

The parameter set is where Θ^{t}={\tilde{θ}¹, . . . , \tilde{θ}^{t-1}, θ^{t}}, Θ^{t} indicates the entire parameter set learned at the current time point t, \tilde{θ}^{t-1} indicates a parameter learned in a previous task, and θ^{t} indicates the parameters for a new task. This enables effective learning of the new task while retaining previous information.

In step S530, the continual learning model may perform a process of optimizing the model by applying the loss function based on the learned results after learning the new task. The loss function of the present disclosure may include an allocation loss function and a sparsity loss function, and the loss function may be designed to ensure that new information is effectively learned while minimizing the loss of previous information during the continual learning process. An optimal resource allocation strategy may be applied based on the exploration ratio and exploitation ratio by the allocation loss function, thereby retaining the learning balance between previous tasks and new tasks.

The allocation loss function may be defined as follows.

$${ℒ}_{alloc} = {𝔼}_{{E}^{t - 1} \sim A} {\sum }_{i = t - 1}^{t} {\sum }_{n = 1}^{{N}^{i}} {ℒ}_{task} ( C ( {x}_{n}^{i} ; {Θ}^{t} , {E}^{i} ) ) \qquad [ Equation 6 ]$$

Here, [symbol] _{alloc} is an allocation loss function that adjusts parameter resource competition between a new task and a previous task. [symbol] E^{t-1}~A is an expected value of the exploitation ratio based on the resource allocation model, [symbol] ₜₐₛₖ represents a cross-entropy loss function, C is the neural network that constitutes the continual learning model,

$${x}_{n}^{i}$$

is n-th data included in an i-th task, Θ^{t} is a parameter set for an entire task learned at the current time point t, and Eⁱ represents an exploitation ratio used in the i-th task. The optimal exploration and exploitation strategy may be determined in a process of minimizing the allocation loss function.

In addition, sparsity loss may be applied to prevent the previous task from occupying excessive resources, which may serve to reduce unnecessary memory consumption and computation amount by limiting the number of parameters used in a specific layer.

The sparsity loss function may be defined as follows.

$${ℒ}_{sparse} = \frac{1}{L} {\sum }_{l = 1}^{L} {( \frac{\text{?}}{τ} )}^{2} \qquad [ Equation 7 ]$$

$$\text{?} \text{indicates text missing or illegible when filed}$$

Here, L represents the number of neural network layers,

$$\text{?}$$

$$\text{?} \text{indicates text missing or illegible when filed}$$

indicates an exploitation ratio used by the previous task at the layer l, and τ is a hyperparameter that limits the exploitation ratio. The sparsity loss function prevents the previous task from using excessive resources.

The resource allocation model may be optimized by the exploration ratio and exploitation ratio that minimize the sum of the allocation loss function and sparsity loss function.

In step S540, the continual learning model may perform a process of re-learning the parameters of the previous task based on the optimized learning results. It may be necessary to update previous parameters to reflect changes that occur during the learning process of a new task, while retaining information from the previous task. To this end, the continual learning model may retrain the model of the previous task based on the optimal allocation ratio, thereby reflecting important information found during the new task learning process while retaining the learning performance of the previous task.

The loss function for re-learning the previous task using the optimal resource allocation ratio derived from the resource allocation model may be defined as follows.)

$${min}_{{\tilde{θ}}^{t - 1}} {ℒ}_{task} ( C ( {x}_{n}^{i} ; {Θ}^{t} , {\tilde{E}}^{i} ) ) \qquad [ Equation 8 ]$$

Here,

$$\text{?}$$

$$\text{?} \text{indicates text missing or illegible when filed}$$

is a formula that optimizes some parameters of a previous task, \tilde{θ}^{t-1} is a parameter of a previous task being relearned, [symbol] ₜₐₛₖ is a function that minimizes the loss of an i-th task, C is a neural network that constitutes a continual learning model,

$${x}_{n}^{i}$$

is n-th data included in an i-th task, Θ^{t} is a set of parameter sets for all tasks learned at a current time point t, and \tilde{E}ⁱ represents an optimal allocation ratio of a previous task determined by an resource allocation model.

The performance degradation of the previous task may be prevented by optimizing the loss function for re-learning. Through this, the continual learning model of the present disclosure can provide a learning structure with which new information can be effectively learned while retaining the balance between the previous task and the new task without losing previous information.

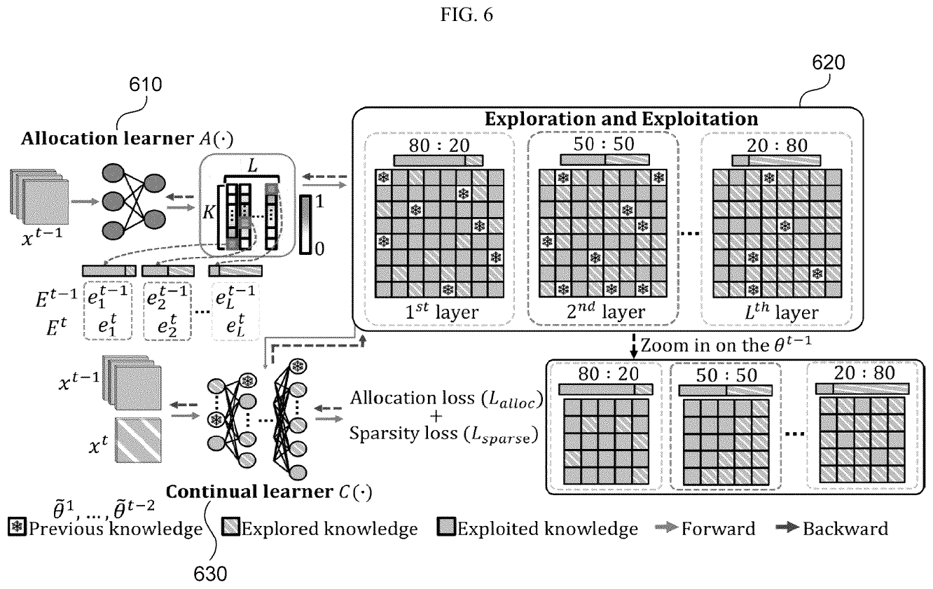

FIG. 6 is a diagram illustrating learning of a continual learning model based on an exploration ratio and an exploitation ratio and optimization of an resource allocation model using a loss function according to an embodiment of the present disclosure.

FIG. 6 illustrates a process in which a resource allocation model 610 and a continual learning model 630 cooperate to adjust exploration and exploitation in a continual learning environment. In particular, it illustrates a method for optimizing the balance between exploration and exploitation in the process of determining how much information learned from a previous task to retain and how much resources to explore in a new task. In addition, it may visually illustrate a process of balancing exploration and exploitation 620 to show how resources are distributed in each layer.

The resource allocation model 610 may play a role in determining information learned from a previous task and resource distribution for learning a new task in continual learning. The resource allocation model may determine an exploitation ratio E^{t-1} and an exploration ratio E^{t} for each layer by receiving input data x^{t-1} learned from the previous task. Through this, it is possible to determine whether to retain the learned information or learn a new task in consideration of the importance of each layer. In particular, the resource allocation model may be designed to retain the balance between exploration and exploitation while minimizing the loss of used resources.

The resource allocation model may perform the following key functions. First, the resource allocation model may calculate the probability distribution for the parameters learned from the previous task, and determine the exploration ratio and exploitation ratio for each layer based on the probability distribution. To this end, the resource allocation model may apply a probability model for each layer of the neural network to probabilistically analyze whether it is advantageous to retain information of a previous task or whether additional exploration is required for learning a new task. Second, the resource allocation model may perform resource allocation based on probability distribution. The allocation model may retain existing information by allocating a high utilization ratio when information from the previous task is important in a specific layer, and conversely, may increase the exploration ratio to enable learning of new information when learning a new task is required. Through this, the continual learning model may be designed to effectively adapt to a new task while preserving existing learned information.

Reference numeral 620 in FIG. 6 visually shows how exploration and exploitation are adjusted at each layer. The process of adjusting exploration and exploitation may be performed in the following manner.

In the first layer (80:20 ratio), 80% of the information learned from a previous task is retained, and 20% of the exploration for a new task may be performed. In a layer where previously learned knowledge is important, previous information may be actively used. The second layer (50:50 ratio) can represent a case where information from previous tasks and learning of new tasks occur equally. The second layer (50:50 ratio) may indicate a case in which the information from a previous task and learning of the new task are performed equally. When learning a new task is required, it may be designed to learn new information while retaining half of the previous information. In the l-th layer (20:80 ratio), only 20% of the information from the previous task is retained and 80% is allocated to learning a new task. When the importance of previous information is low, it may be adjusted so that new information is actively explored and learned.

As such, a method of retaining an optimal balance for adjusting the exploitation of previous information and exploration for new information may be applied for each layer. In addition, by enlarging some of the parameters learned from the previous task, it is possible to visually show how the optimization between exploration and exploitation is probabilistically achieved. In this process, the exploration ratio may be adjusted to learn new information while retaining important information from the previous task. This enables the continual learning model to efficiently use resources for learning the new task while retaining previous information in a specific layer.

The continual learning model 630 may actually perform the role of training the model based on the exploration ratio and exploitation ratio determined by the resource allocation model 610. The continual learning model may perform the following core learning processes. The continual learning model may perform optimization through the allocation loss function and sparsity loss function. The allocation loss function may be adjusted to learn new information while preventing loss of previous information by optimizing the exploration and exploitation ratio. The scarcity loss may be designed to prevent excessive resource exploitation in a specific layer and minimize unnecessary learning resources.

Through this process, the continual learning model may be designed to achieve optimal learning performance while maintaining a balance between previous information and new information. In addition, the continual learning model may efficiently perform resource distribution between the previous task and the new task by adjusting the exploration ratio and exploitation ratio. This enables the continual learning model to perform optimal resource distribution for learning new information while retaining previous information when learning a new task.

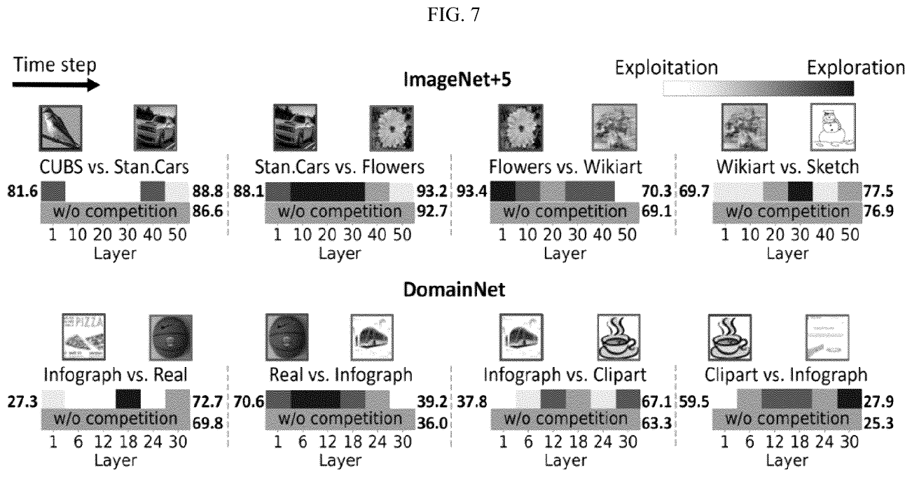

FIG. 7 is a diagram illustrating the results of resource competition based on an exploration ratio and an exploitation ratio of a uniform allocation method and a continual learning model according to an embodiment of the present disclosure.

The present disclosure may propose a method for effectively learning a new task while retaining information learned from an existing task by optimizing the exploration and exploitation ratio in a continual learning environment. FIG. 7 illustrates a result of visually comparing the effects of exploration ratio and exploitation ratio in a continual learning environment using the ImageNet+5 and DomainNet data sets.

The upper part of FIG. 7 shows the results of continual task learning on the ImageNet+5 dataset, and the lower part thereof shows the results of continual task learning on the DomainNet dataset. In each experiment, the performance difference can be analyzed when the corresponding model continuously learns a new task after learning a specific task. To this end, in the present disclosure, two cases were compared. The first is the case where the continual learning model performed learning by optimizing the exploration ratio and exploitation ratio in a continual learning model, and the second is the case where the model was trained in a situation without competition (w/o competition).

As can be seen from FIG. 7, when the continual learning model of the present disclosure was applied (when exploration and exploitation were optimized), it was able to retain better performance overall. For example, in the Flowers vs. Wikiart task, it was able to minimize the performance degradation of the model by performing an appropriate exploration for a new task while partially retaining the existing learned task information (exploitation). On the other hand, in an environment without competition (w/o competition), too many resources may be allocated to new tasks, or information from existing tasks may be excessively retained, making it difficult to learn new information.

A similar pattern can be observed in the results of DomainNet data at the lower part. For example, in the Infograph vs. Clipart task, a model for which the exploration ratio and exploitation ratio are optimized learned existing information and new information in a balanced manner to achieve 67.1% performance, but in the environment without competition, a performance degradation of 63% occurred. This can demonstrate that the continual learning model of the present disclosure can optimize learning for a new task while retaining knowledge from the existing task.

In the present disclosure, a resource allocation optimization model can be applied to automatically adjust the exploration ratio and exploitation ratio, thereby determining an optimal resource distribution strategy for each layer in a continual learning environment. In particular, as can be seen in the drawing, the exploration ratio and exploitation ratio can be applied differently for each layer for a specific task, which can be an important factor in maximizing learning performance in the continual learning environment. The continual learning model of the present disclosure effectively performs new task learning while minimizing the loss of existing learning information by adjusting such resource competition.

The system for determining the resource allocation ratio of the continual learning model described with reference to FIGS. 1 to 7 may be implemented in the form of a computer program stored in a computer-readable recording medium executed by a computer or a recording medium including instructions executable by a computer. In addition, the method of determining the resource allocation ratio of the continual learning model described with reference to FIGS. 1 to 7 may be implemented in the form of a computer program stored in a computer-readable recording medium executed by a computer.

The computer-readable recording medium may be any available medium that can be accessed by a computer, and includes both volatile and non-volatile media, removable and non-removable media. In addition, the computer-readable recording medium may include a computer storage medium. The computer storage medium includes both volatile and nonvolatile, removable and non-removable media implemented by any method or technology for storing information such as computer-readable instructions, data structures, program modules or other data.

Examples of program instructions include not only machine language code, such as that produced by a compiler, but also high-level language code that can be executed by a computer using an interpreter or the like. The hardware device may be configured to operate as one or more software modules to perform the processing according to the present disclosure, and vice versa.

According to a disclosed embodiment, task-specific customized resource allocation in a continual learning environment is possible, and learning performance can be improved by optimizing a balance between exploration and exploitation. The existing method had limitations in that it was difficult to exploit resources optimally and computational costs are excessively incurred because it required a person to directly set resource distribution between tasks or used a method that allocated resources to all tasks at the same ratio. However, in the present disclosure, the resources required by each task can be automatically explored through an resource allocation model and an optimal allocation strategy can be established to maintain high learning performance while minimizing computational costs.

The above description of the present disclosure is for illustrative purposes only, and those skilled in the art to which the present disclosure pertains will understand that the present disclosure may be easily modified into other specific forms without changing the technical spirit or essential features of the present disclosure. Therefore, the embodiments described above should be understood as illustrative in all respects and not restrictive. For example, each component described as a single type may be implemented in a distributed manner, and similarly, components described as being distributed may be implemented in a combined form.

Although representative embodiments of the present disclosure have been described in detail above, those skilled in the art will understand that various modifications may be made to the above-described embodiments without departing from the scope of the present disclosure. Therefore, the scope of protection of the present disclosure should not be limited to the described embodiments, but should be defined not only by the claims set forth below but also by equivalents thereof.

What is claimed is:

1. A learning method performed on a computing device including one or more processors and a memory storing one or more programs executed by the one or more processors, the method comprising:
acquiring, by a continual learning model, a learned parameter set obtained by performing learning on a previous task; and
determining, by a resource allocation model, a resource allocation ratio between an exploration ratio for learning information of the new task with respect to the parameter set and an exploitation ratio for retaining knowledge of the previous task when the new task is input.

2. The learning method of claim 1, wherein the determining of the resource allocation ratio includes:
calculating a probability distribution by inputting the previous task into the resource allocation model; and
determining the exploration ratio and the exploitation ratio based on the probability distribution.

3. The learning method of claim 2, wherein the probability distribution is calculated by the resource allocation model receiving the previous task as input and probabilistically calculating the exploitation ratio of a parameter for each layer in a continual learning model so that an optimal exploitation ratio is selected in each layer.

4. The learning method of claim 3, wherein the probability distribution of the resource allocation model is calculated by Equation 1:
$$𝒫 = softmax ( A ( {x}_{n}^{t - 1} ; 𝒲 ) ) ∈ {ℝ}^{K \times L} \qquad [ Equation 1 ]$$
where [symbol] is the probability distribution of an exploitation ratio;
A is a neural network that constitutes a resource allocation model;
$${x}_{n}^{t - 1}$$
is an n-th data sample of a previous task; [symbol]
is a learnable parameter that determines an exploitation ratio;
K is the number of exploitation ratio hyperparameters; and
L represents the number of layers of a neural network.

5. The learning method of claim 3, wherein the determining of the exploration ratio and the exploitation ratio includes:
determining an exploitation ratio of a parameter for each of a plurality of layers of the previous task based on a probability value for each layer according to the probability distribution; and
determining a residual resource except for the determined exploitation ratio among the parameter set as an exploration ratio to be allocated to the new task.

6. The learning method of claim 1, further comprising:
performing learning on the new task by the continual learning model,
wherein the performing of the learning on the new task includes:
acquiring, by the continual learning model, the resource allocation ratio between the exploration ratio and the exploitation ratio determined by the resource allocation model; and
learning, a new task by allocating a parameter according to the resource allocation ratio determined to the new task.

7. The learning method of claim 6, wherein the resource allocation model is trained through a preset loss function using a result of the continual learning, and
the loss function includes an allocation loss function that allows the continual learning model to perform optimal resource distribution by minimizing a learning loss between the previous task and the new task.

8. The learning method of claim 7, wherein the allocation loss function is expressed by Equation 2:
$${ℒ}_{alloc} = \text{?} {\sum }_{i = t - 1}^{t} \text{?} {ℒ}_{task} ( C ( {x}_{n}^{i} ; {Θ}^{t} , \text{?} ) ) \qquad [ Equation 2 ]$$
$$\text{?} \text{indicates text missing or illegible when filed}$$
where [symbol] _{alloc} is an allocation loss function that adjusts parameter resource competition between a new task and a previous task; [symbol]
E^{t-1}~A is an expected value of the exploitation ratio based on the resource allocation model; [symbol]
ₜₐₛₖ represents a cross-entropy loss function;
C is the neural network that constitutes the continual learning model;
$${x}_{n}^{i}$$
is n-th data included in an i-th task;
Θ^{t} is a parameter set for an entire task learned at the current time point t; and
Eⁱ represents the exploitation ratio used in the i-th task.

9. The learning method of claim 7, wherein the loss function further includes a sparsity loss function for preventing excessive exploitation of parameter resources from the previous task in the continual learning model.

10. The learning method of claim 9, wherein the sparsity loss function is expressed by Equation 3:
$${ℒ}_{sparse} = \frac{1}{L} \text{?} {( \frac{\text{?}}{τ} )}^{2} \qquad [ Equation 3 ]$$
$$\text{?} \text{indicates text missing or illegible when filed}$$
where [symbol] ₛₚₐᵣₛₑ: sparsity loss function that prevents a previous task from occupying excessive resources;
L represents the number of neural network layers;
$$\text{?}$$
$$\text{?} \text{indicates text missing or illegible when filed}$$
represents an exploitation ratio used by a previous task in a layer l; and
τ is a hyperparameter that limits the exploitation ratio.

11. The learning method of claim 7, wherein the resource allocation model is trained to minimize a sum of the allocation loss function and the sparsity loss function.

12. The learning method of claim 11, further comprising:
re-learning, by the continual learning model, the previous task through the preset loss function based on the optimal allocation ratio; and
optimizing the parameter of the previous task through the re-learning.

13. The learning method of claim 12, wherein the loss function for the re-learning is expressed by Equation 4:
$$\text{?} {ℒ}_{task} ( C ( {x}_{n}^{i} ; {Θ}^{t} , \text{?} ) ) \qquad [ Equation 4 ]$$
$$\text{?} \text{indicates text missing or illegible when filed}$$
where
$$\text{?}$$
$$\text{?} \text{indicates text missing or illegible when filed}$$
is a formula that optimizes some parameters of a previous task;
\tilde{θ}^{t-1} is parameters of the previous task being relearned; [symbol]
ₜₐₛₖ is a function that minimizes the loss of an i-th task;
C is a neural network that constitutes a continual learning model;
$${x}_{n}^{i}$$
is n-th data included in the i-th task;
Θ^{t} is a set of parameter sets for all tasks learned at a current time point t; and
\tilde{E}ⁱ represents an optimal allocation ratio of a previous task determined by an resource allocation model.

14. A computing device comprising:
a processor; and
a memory configured to store one or more programs executed by the processor,
wherein the processor is configured to perform:
an operation of acquiring, by a continual learning model, a learned parameter set obtained by performing learning on a previous task; and
an operation of determining, by a resource allocation model, a resource allocation ratio between an exploration ratio for learning information of the new task with respect to the parameter set and an exploitation ratio for retaining knowledge of the previous task when the new task is input.

15. The computing device of claim 14, wherein the processor further includes performing learning on the new task by the continual learning model, and
the learning on the new task further includes:
an operation of acquiring, by the continual learning model, the resource allocation ratio between the exploration ratio and the exploitation ratio determined by the resource allocation model, and
an operation of learning, a new task by allocating a parameter according to the resource allocation ratio determined to the new task.

16. A computer program stored in a non-transitory computer readable storage medium, wherein the computer program includes one or more instructions, and the instructions, when executed by a computing device including one or more processors, cause the computing device to perform:
acquiring, by a continual learning model, a learned parameter set obtained by performing learning on a previous task; and
determining, by a resource allocation model, a resource allocation ratio between an exploration ratio for learning information of the new task with respect to the parameter set and an exploitation ratio for retaining knowledge of the previous task when the new task is input.
